(19) United States
(12) Patent Application Publication
(10) Pub. No.: US 2025/0013854 A1
(43) Pub. Date: Jan. 9, 2025

(54) METHOD AND SYSTEM FOR TEMPORAL KNOWLEDGE GRAPH FORECASTING BASED ON PATTERN RECOGNITION

(71) Applicant: NEC Laboratories Europe GmbH, Heidelberg (DE)

(72) Inventors: Julia GASTINGER, Heidelberg (DE); Timo SZTYLER, Heidelberg (DE)

(21) Appl. No.: 18/712,253

(22) PCT Filed: Feb. 17, 2022
(86) PCT No.: PCT/EP2022/053994

§ 371 Date: May 22, 2024

(30) Foreign Application Priority Data
Nov. 23, 2021 (EP) 21210021.8

(51) Int. Cl. G06N 3/044; G06N 5/022; G06Q 50/26

(52) U.S. Cl. CPC G06N 3/044; G06N 5/022; G06Q 50/265

(57) ABSTRACT

A predictive policing system includes a database of crime related scenarios in a number of past timesteps represented as temporal knowledge graphs (TKGs). Crime prediction devices generate relationship vectors that describe relations for each node of the TKGs for each available timestep. A dataset is created including vector sequences sets for each node of the TKGs, which are used as sequential inputs for training a pattern model to predict future relations for each node of the TKGs. A forecasting model is trained to predict nodes of the TKGs associated with each of the predicted future relations. Predicted future TKGs are assembled describing a crime scenario in an area of interest per future time steps of interest. A forecasting-based action recommendation system computes actions to steer the predicted scenario towards a desired scenario. Monitoring and/or surveillance devices deployed in the area of interest are adapted based on the computed actions.

### CROSS REFERENCE TO RELATED APPLICATIONS

This application is a U.S. National Phase application under 35 U.S.C. § 371 of International Application No. PCT/EP2022/053994, filed on Feb. 17, 2022, and claims benefit to European Patent Application No. EP 21210021.8, filed on Nov. 23, 2021. The International Application was published in English on Jun. 1, 2023 as WO 2023/094033 A1 under PCT Article 21(2).

### FIELD

The present invention relates to a method, system and computer-readable medium for Temporal Knowledge Graph, TKG, forecasting.

Furthermore, the present invention relates a predictive policing method and system.

### BACKGROUND

Knowledge graphs (KGs) are an important formalism to represent structured data, i.e. to organize, manage, and retrieve structured information and are widely used in numerous application domains. In this regard, the nodes of a KG represent real-world entities along with their types and attributes, while the edges of a KG represent relationships between the entities.

Typically, a KG is of the form G=(E, R), where E is a set of entities and, R is a set of relation types. One can represent G as a set of triples of the form (subject, relation, object), e.g. denoted as (s, r, o). The incompleteness of most real-world KGs has stimulated research on predicting missing relations between entities, i.e. (s, ?, o), as well as predicting most probable completion of a subject or an object of a triple, i.e. (?, r, o) or (s, r, ?), respectively.

According to prior art, when trying to solve the task of forecasting future scenarios with given resources, the following problems arise:

Humans suffer from information overload: The amount of data typically involved in real-world scenarios represented by TKGs, including the relations between entities and the underlying pattern (across entities and across time), are typically too large and too complex to be processed by humans. As such, humans are not capable of reliably predicting the future of scenarios for given embodiments.

Existing ML-based forecasting methods that are not graph-based cannot take into account the relations between entities, and in general the graph structure, and are thus not able to incorporate all available information.

Where existing Knowledge Graph-based forecasting methods (i.e. forecasting for TKGs) are able to deal with a big amount of relational data, as well as in general the graph structure, they do not consider all the information available in the TKGs. For example, CyGNet (as described in Zhu, Cunchao, Muhao Chen, Changjun Fan, Guangquan Cheng, and Yan Zhan. “Learning from History: Modeling Temporal Knowledge Graphs with Sequential Copy-Generation Networks.” arXiv preprint arXiv:2012.08492 (2020)) only takes into account intuition of the form “what happened before, could happen again”, by selecting entities that form repeated facts in the history.

Further, xERrte (as described in Han, Zhen, Peng Chen, Yunpu Ma, and Volker Tresp. “Explainable Subgraph Reasoning for Forecasting on Temporal Knowledge Graphs.” In International Conference on Learning Representations. 2020) infers future facts by reasoning over so-called query-relevant subgraphs (sampled from neighborhood of a query), and thus only takes into account an intuition of the form “what happens frequently in the neighborhood, might also happen to the query of interest”.

In addition, REGCN (as described in Li, Zixuan, Xiaolong Jin, Wei Li, Saiping Guan, Jiafeng Guo, Huawei Shen, Yuanzhuo Wang, and Xueqi Cheng. “Temporal Knowledge Graph Reasoning Based on Evolutional Representation Learning.” arXiv preprint arXiv:2104.10353 (2021)) models the historical knowledge graph sequence auto-regressively, and captures the structural dependencies within a KG at each timestep.

Further, CluSTeR (as described in Li, Zixuan, Xiaolong Jin, Saiping Guan, Wei Li, Jiafeng Guo, Yuanzhuo Wang, and Xueqi Cheng. “Search from History and Reason for Future: Two-stage Reasoning on Temporal Knowledge Graphs.” arXiv preprint arXiv:2106.00327 (2021)), is a method that first searches so-called clue paths related to a given query and then models the temporal information along those clue facts. This takes into account an intuition of the form “what happened before, could happen again”, but does not take into account the information on the global graph.

Further, NODE (as described in Ding, Zifeng, Zhen Han, Yunpu Ma, and Volker Tresp. “Temporal Knowledge Graph Forecasting with Neural ODE.” arXiv preprint arXiv:2101.05151 (2021)), aggregates graph information and uses Neural Ordinary Differential Equations to predict future graphs, not specifically taking into account any of the above mentioned intuitions.

In addition, RENet (as described in Jin, Woojeong, Meng Qu, Xisen Jin, and Xiang Ren. “Recurrent Event Network: Autoregressive Structure Inference over Temporal Knowledge Graphs.” In Proceedings of the 2020 Conference on Empirical Methods in Natural Language Processing (EMINLP), pp. 6669-6683. 2020), learns the temporal dependency from the sequence of graphs and the local structural dependency from the neighborhood, but does not explicitly focus on extracting pattern for specific relations (e.g., of the form “what has happened to node x might as well happen to node z at a later step in time”) or entities (e.g., of the form “what happened before, could happen again”).

### SUMMARY

In an embodiment, the present disclosure provides a predictive policing system, the system comprising: a database comprising crime related scenario states in a number of past timesteps represented as temporal knowledge graphs (TKGs); one or more crime prediction processing devices that, alone or in combination, are configured to provide for execution of the following steps: generating, based on the TKGs stored in the database, relationship vectors that describe relations for each node of the TKGs for each available timestep; using the generated relationship vectors to create a sequential dataset including at least one vector sequence set for each node of the TKGs; using the at least one vector sequence set as sequential input samples for training and execution of a pattern model that is learned to predict, for one or more future timesteps of interest, future relations for each node of the TKGs; training and execution of a forecasting model that is learned to predict, for one or more future timesteps of interest, nodes of the TKGs associated with each of the predicted future relations; using the predicted future relations and nodes to assemble predicted future TKGs describing a crime related scenario in an area of interest per future time steps of interest; a forecasting-based action recommendation system configured to iteratively compute one or more actions acting on the predicted future crime related scenario that steer the predicted future crime related scenario towards a desired scenario; and control means configured to automatically adapt monitoring and/or surveillance devices deployed in the area of interest based on the computed one or more actions.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating a system for TKG forecasting in accordance with an embodiment of the present invention;

FIGS. 2a-d are schematic views illustrating the steps of relationship prediction in a system for TKG forecasting in accordance with an embodiment of the present invention;

FIGS. 3a-d are schematic views illustrating the steps of entity prediction in a system for TKG forecasting in accordance with an embodiment of the present invention; and

FIG. 4 is a schematic view illustrating a TKG forecasting system embedded into a forecasting-based action recommender in accordance with an embodiment of the present invention.

Detailed Description In accordance with an embodiment, the present invention improves and further develops a predictive policing system as well as a method and a system for TKG forecasting in such a way that as much as possible of the available information is taken into consideration.

In accordance with another embodiment, the present invention provides a predictive policing system, the system comprising a database containing crime related scenario states in a number of past timesteps represented as TKGs; one or more crime prediction processing devices that, alone or in combination, are configured to provide for the execution of the following steps: generating, based on the TKGs contained in the database, relationship vectors that describe the relations for each node of the graphs for each available timestep; using the generated relationship vectors to create a sequential dataset including at least one vector sequence set for each node of the graphs; using the vector sequence sets as sequential input samples for training and execution of a pattern model that is learned to predict for one or more future timesteps of interest future relations for each node of the graphs; training and execution of a forecasting model that is learned to predict for one or more future timesteps of interest the nodes of the graphs associated with each of the predicted future relations; and using the predicted future relations and nodes to assemble predicted future TKGs describing a crime related scenario in an area of interest per future time steps of interest. The predictive policing system further comprises a forecasting-based action recommendation system configured to iteratively compute one or more actions acting on the predicted future crime related scenario that steer the predicted future scenario towards a desired scenario; and control means configured to automatically adapt monitoring and/or surveillance devices deployed in the area of interest based on the computed one or more actions.

Furthermore, in accordance with another embodiment, the present invention provides a method for Temporal Knowledge Graph, TKG, forecasting, the method comprising: generating, by a relation prediction module based on a graph database containing scenario states in a number of past timesteps represented as TKGs, relationship vectors that describe the relations for each node of the graphs for each available timestep; using, by the relation prediction module, the generated relationship vectors to create a sequential dataset including at least one vector sequence set for each node of the graphs; using, by the relation prediction module, the vector sequence sets as sequential input samples for training and execution of a pattern model that is learned to predict for one or more future timesteps of interest future relations for each node of the graphs; and training and execution, by an entity prediction module, of a forecasting model that is learned to predict for one or more future timesteps of interest the nodes of the graphs associated with each of the predicted future relations.

Furthermore, in accordance with another embodiment, the present invention provides a processing system for TKG forecasting, and by a tangible, non-transitory computer-readable medium according to the independent claims.

The present invention focusses on temporal knowledge graphs (TKGs) where some triples are augmented with time information and the link prediction problem asks for the most probable completion given time information. More formally, a TKG G=(E, R, T) is a KG where facts have the form (subject, relation, object, timestamp), e.g. denoted as quadruples of the form (s, r, o, t). Embodiments of the present invention aim at forecasting future scenarios using TKGs, addressing the problem of predicting how a situation will develop in the future, based on its structural and relational properties.

The present invention describes a method for Temporal Knowledge Graph Forecasting based on Pattern Recognition that solves the problem to predict how a situation will develop in the future, based on its structural and relational properties. It includes two steps, relation prediction, and entity prediction. As compared to state of the art in classical ML-based forecasting methods (i.e. non Graph-based), the method according to embodiments of the invention can take into account the relations between entities, and in general the graph structure, and is thus able to incorporate significantly more available information. This leads to more enhanced, and thus more accurate prediction of our invention as compared to classical ML-based forecasting methods.

The operational performance of the processing system according to the present invention depends on how well the graphs are forecast, i.e. how well it can predict the relations and entities. As a consequence, enough training data, i.e. data from previous time steps or data from previous cases in the database, has to be available—otherwise leading to limited functionality of the graph forecasting method. Preferably, the data has to have a relational aspects, i.e. relations between entities, otherwise a knowledge graph is not a suitable data structure. Further, in order to benefit from the full potential of the invention, there needs to be a pattern aspect in the data across time and across the graph, e.g., repetition of entities and relations over time.

According to one aspect, the present invention relates to a method and system for temporal knowledge graph forecasting based on pattern recognition using historical data. The forecasting is performed in a two steps approach including relation prediction and entity prediction. Further, in relation prediction the creation of relation vectors may be performed in an initial step to describe the relationships of each node for each time-step from the stored history and then encoding and sequencing may be performed of a particular pattern model. After that, training and execution may be performed to predict future encoded relationship vectors. Furthermore, after performing the relation prediction, the entity prediction may be performed by creating the matrix for each relation for each time-step, including the relation vectors, and then training the model based on the inputs. After training, a selection process may be performed using the most likely entity for each predicted pattern.

In an embodiment, the present invention provides a method for Temporal Knowledge Graph Forecasting based on Pattern Recognition, the method comprising the steps of:
1) Relation Prediction, to predict for each node, for the timestep of interest, the in- and outgoing relations based on a history of Temporal Knowledge Graph snapshots, consisting of the following substeps:
   a. Creation of a Relation Vector to describe the relationships for each node for each timestep from the history,
   b. Optionally encoding of the Relation Vector for Dimensionality Reduction,
   c. Creation of the Sequence Set as Input for the Pattern Model,
   d. Training and Execution of the Pattern Model to predict future encoded relationship vectors.
2) Entity Prediction, to predict for each predicted relations the connected entities, consisting of the following substeps:
   a. Creation of a similarity matrix for each relation for each timestep, including the relation embedding, and the computation of similarity values between relation embeddings,
   b. Optionally dimensionality reduction of the relation similarity matrices,
   c. Training and Execution of a Forecasting model to forecast future relation matrices for each relation, and decompression of future relation matrices,
   d. Selection of predicted most likely entity for each predicted [subject, relation], or [relation, object], based on a weighted combination of the extracted forecasted value from the future relation matrix, and, potentially, the neighborhood boost relation matrix.

According to embodiments of the invention, the forecasting model defines temporal knowledge graph forecasting as pattern recognition problem: Relation Prediction followed by Entity Prediction. Predicting the relations independent of the corresponding object enables to capture the development of the attributes of an entity across time. Predicting the entities (objects) in a downstream approach for each predicted relation enables to capture occurring patterns for these entities across time and across the full graph. This enabled to predict entities (objects) for relations that were never connected to these relations before by exploiting the semantic similarity across existing edge types.

According to embodiments of the invention, predicting relations is based on a matrix that describes the relations for the full graph in a sequential way. This enables to capture pattern for relationships across the full graph and across time.

According to embodiments of the invention, the predicted entities (objects) may be filtered by exploiting the neighborhood (i.e., similar/related entities) and by prioritizing predicted entities that also occur in the neighborhood.

There are several ways how to design and further develop the teaching of the present invention in an advantageous way. To this end, it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawing

The present invention provides a method and a system of forecasting future Temporal Knowledge Graph(s), TKGs, based on pattern recognition. It solves the problem of predicting how a situation will develop in the future, based on its structural and relational properties, and based on detecting the underlying pattern (across entities in the graphs, as well as across time).

According to embodiments of the invention, the solution to the above problem is divided into two steps: step 1—relation prediction, and step 2—entity prediction. The underlying assumption is, that there are pattern over time in the relations (step 1) as well as in the entities belonging to the relations (step 2).

In an embodiment, step 1 is constructed to solve the problem of predicting all existing relations in a graph for timestep(s) of interest for each node of the graph. An intuition for how embodiments of the invention tackle the first step (relation prediction) is as follows:
(ia) What has happened to node x might as well happen to node z at a later step in time e.g., because node x is of similar type than node z, but further ahead in its development.

When solving the problem of predicting relations, a relation-prediction model may learn the underlying pattern, extract the important information, and filter out non-important information.

In an embodiment, step 2 is constructed to solve the problem of predicting entities for each predicted relationship. An intuition for how embodiments of the invention tackle the second step is as follows:
(iia) What happened before, could happen again (e.g., [x, eat, breakfast, 8 am Monday]->[x, eat, breakfast, 8 am Tuesday]) or could be an indicator of what might happen (e.g., [x, eat, breakfast, 8 am]->[x, wash, dishes, 9 am]),
(iib) What happens globally in the graph, could also happen to the query of interest,
(iic) What happens frequently in the neighborhood, might also happen to the query of interest.

When solving the problem of predicting entities, an entity-prediction model may learn the underlying pattern, extract the important information, and filter out non-important information.

By the integration of the intuition as described above Embodiments of the present invention provide the following advantageous features:
detecting and predicting relations for a node of interest based on patterns which repeatedly occur across the graph, in accordance with intuition (ia)
detecting and predicting entities based on entities that occurred before queries of interest, or usually occur in sequence to preceding queries of interest, in accordance with intuition (iia)
detecting and predicting entities based on the global graph history, in accordance with intuition (iib)
detecting and predicting entities based on the neighborhood of the query of interest, in accordance with intuition (iic).

No other prior art Knowledge Graph-based Forecasting Method is able to combine all mentioned features. Because embodiments of the present invention combine those features by detecting pattern in the sequential and relational data in two steps, it is possible to extract the important information, and filter out non-important information, and thus to predict in a more enhanced way as compared to other Knowledge Graph-based Forecasting Methods.

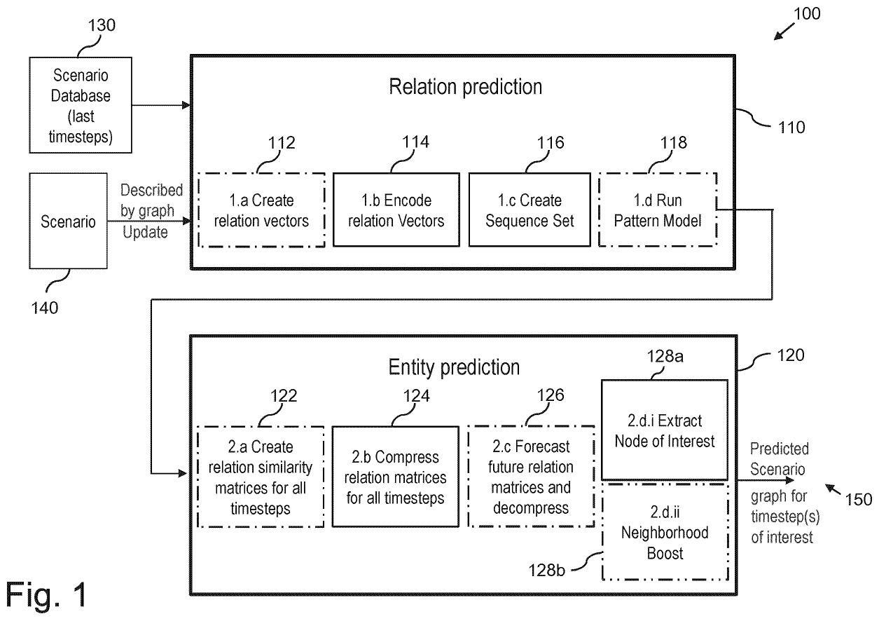

As already mentioned above, according to embodiments, the method/system is based on the execution of two main steps, wherein a first step is directed to a prediction of relations, while a second step is directed to a prediction of entities. FIG. 1 illustrates an overview of a forecasting system 100 in accordance with this embodiment, including a relation prediction module 110 configured to execute the first step and an entity prediction module 120 configured to execute the second step. In the context of the embodiment illustrated in FIG. 1, it is an objective of the invention to forecast, given graph history, a TKG for future timesteps, with each TKG representing one timestep from a (real world) scenario, based on detecting the underlying pattern in the data.

As shown in FIG. 1, the input to the relation prediction module 110 of the future TKG forecasting system 100 is a scenario database 130, which is a graph database that contains the scenario states in the last timesteps, represented as TKGs (one graph per timestep). The number of previous scenario states provided in the scenario database 130 can be freely chosen, depending on the availability of the data.

Further, additional input is also the most recent scenario, represented as a TKG and referred to hereinafter as Scenario TKG 140. The Scenario TKG may be updated automatically, whenever the scenario changes.

An example for a Scenario TKG 140 is a Knowledge Graph, which represents the crimes in a city at certain timestamps. Because of the temporal scenario, the information in the Knowledge Graph is represented as quadruples (denoted as [subject, relation, object, timestamp]) instead of triples ([subject, relation, object]) with discrete timestamps. One Temporal Knowledge Graph snapshot consists of all quadruples with the same timestamp. The quadruples in the case of the crime-TKG could be for example [camera, located_at, crossingX, 8 pm], [burglary, happens_at, streetY, 8 pm], [police_officerZ, patrols, districtK, 8 pm], and others.

The output of the entity prediction module 120 of the future TKG forecasting system 100 is a predicted scenario (in form of a TKG) for the timestep(s) of interest, as shown at 150, including predicted relations (in- and outgoing) for all nodes.

Hereinafter, the substeps that, according to embodiments of the invention, may be executed by the relation prediction module 110 as well as by the entity prediction module 120 will be described in more detail.

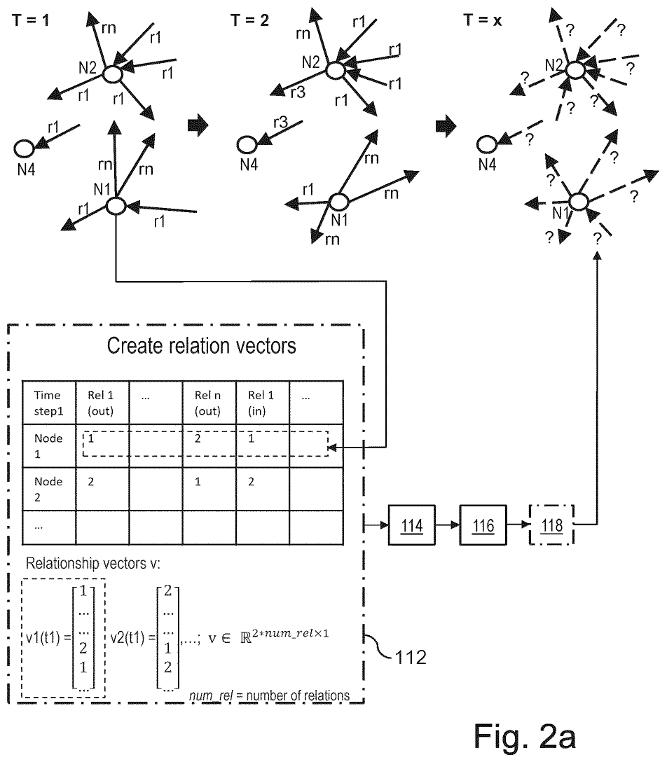

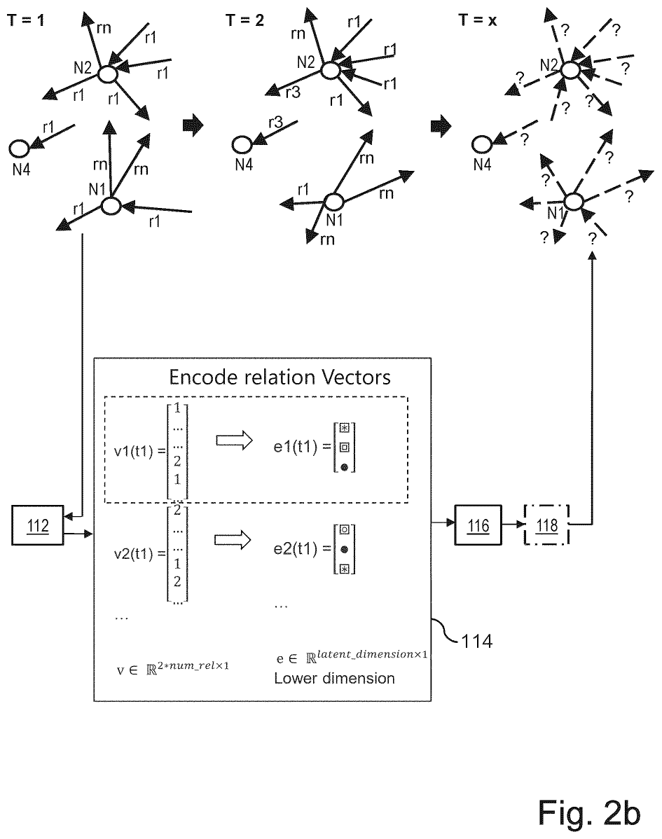

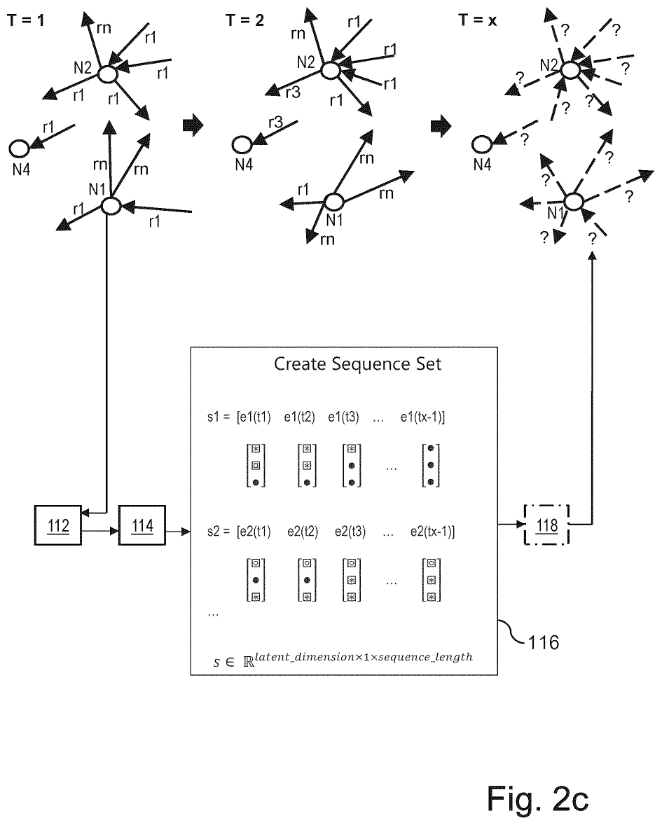

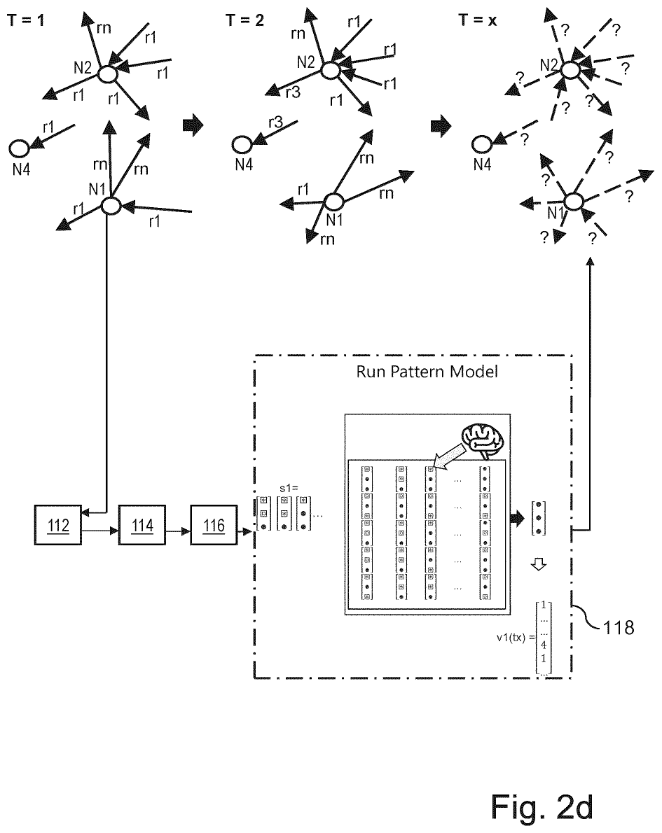

First, the substeps executed by the relation prediction module 110 will be described with reference to FIGS. 2a-2d.

The goal of the relation prediction executed by the relation prediction module 110 is to predict for each node, for the timestep(s) of interest, the in- and outgoing relations based on a history of Temporal Knowledge Graph snapshots.

The input to the Relation Prediction Step is the Scenario Database, including the most recent Scenario, as described above. The output of the Relation Prediction Step are, for the future timestep(s) of interest, the predicted in- and outgoing relationships for each node. If a node will have zero predicted in- and outgoing relationships, it may be assumed that this node will not be present at T=tx.

FIGS. 2a-2d show possible implementations of sub-steps executed by the relation prediction module 110 in accordance with embodiments of the invention, which we will describe in the following.

### Create Relation Vectors (Substep 112)

The goal of the relation vector creation substep 112 is to create a vector that describes the relations for each timestep and each node. The vector may be created by counting the in- and outgoing relations for each node for each timestep. The output of this step are relationship vectors for each node and timestep.

In detail, as exemplary shown in FIG. 2a, one relationship vector v may be created for each node N, N={1, . . . , number_of_nodes}, and each timestep T, T={t1, . . . , tx−1}, with v∈ [symbol] ^{2*num_relx1}, where num_rel is the number of relations. According to an embodiment, the [symbol] creation of the relationship vectors may be based on matrix operations using pytorch tensors.

The step 112 is executed to receive a time-dependent vector representation of the relationships, which may be used in accordance with an embodiment of the invention as the basis for the input to the pattern model (as will be described in more detail below in connection with FIG. 2d).

### Encode Relation Vectors (Substep 114)

The goal of the relation vector encoding sub-step 114 is configured to reduce the dimensionality of the relationship vectors. Due to sparseness of the knowledge graph, in real world applications the relationship vector will typically consist of a large amount of zero entries. The dimensionality reduction may be based on an auto-encoder. The output of this step are the encoded relationship vectors for each node and timestep. The encoded vectors have a reduced number of random variables (beneficial for prediction accuracy) and a reduced vector size (beneficial as less memory need).

As exemplary shown in FIG. 2b, the relation vector encoding sub-step 114 compresses the relationship vector v to an encoded vector e: v∈ [symbol] ^{2*num_relx1}e:∈ [symbol] ^{latent_dimensionx1} with latent_{dimension}≤2*num_rel. In an embodiment of the invention, the dimensionality reduction may be based on an auto-encoder.

According to embodiments of the invention, this step may be implemented as technical enhancement and it may be omitted, where appropriate.

### Create Sequence Set (Substep 116)

The goal of the sequence set creation substep 116 is to create a sequential dataset from the encoded relationship vectors e for the Pattern Model for prediction. This substep will output a sequential dataset.

A sample of the sequential dataset may contain the encoded relationship vectors for multiple timesteps (predefined sequence_length) for one node. In total, the sequential dataset contains the encoded relationship vectors e for all available nodes and all timesteps in the training set.

As exemplary shown in FIG. 2c, the features may consist of the encoded relationship vectors e, leading to s [symbol] ^{pseqence_engthxlatent_dimensionx1}. One sample s contains only samples describing one particular node N={1, . . . , number_of_nodes}. However, multiple samples can describe relationships for the same node N, belonging to different timesteps, e.g., s1=[e1(t1), e1(t2), . . . , e1(ti)]; s2=[e1(t2), e1(t3), . . . , e1(ti+1)], for an exemplary sequence length of i. According to an embodiment, the creation of the sequence set may be based on matrix operations using pytorch tensors.

This step is executed to create a sequential input dataset which may be used in accordance with an embodiment of the invention as the basis for the input to the pattern model (as will be described in more detail below in connection with FIG. 2d). In this case, as the dataset is sequential, the model will be able to learn time dependencies and pattern, and thus to predict future timesteps. According to an embodiment, the sequence set creation substep 116 may be configured to create a dataset which summarizes the information from the whole graph (=containing the samples for all available nodes, as contrary to containing only samples for one node), so that the model will be able to learn pattern across the graph.

### Pattern Model (Substep 118)

The goal of the pattern model run substep 118 is to predict future encoded relationship vectors based on sequential input samples. In an embodiment, the pattern model may be trained in a supervised way on the sequential input dataset.

The pattern model may be a Sequential Model, which learns to predict the i-th element based on the most recent i−1 elements. In accordance with an embodiment of the present invention, the Sequential Model may be realized as Recurrent Neural Network. The model, which is node-independent (because the samples contain embedded relation vectors for all nodes), may be trained to detect pattern across nodes and across timesteps.

The pattern model is configured to learn to extract pattern from the input dataset. An intuition for the pattern model can be described as following: What has happened to node x might as well happen to node z at a later step in time, e.g., because node x is of similar type than node z, but further ahead in its development (in accordance with intuition (ia), as described above). Because the sequential dataset is created from all nodes, and each sample will only contain a subset of sequences, and because a sequential model is trained, the model will be able to learn the pattern, if they repeatedly occur in the graph history.

As exemplary shown in FIG. 2d, the input to the pattern model may be the first sequence_length−1 elements of each sample of the sequence set (=the features). Then, the output is the sequence_length th element of the respective sample (=the target). The pattern model is a Sequential Model, which learns to predict the i-th element based on the most recent i−1 elements. The model is node-independent and is trained to detect pattern across nodes and across timesteps.

The pattern model run substep 118 is executed to learn the (potentially hidden) pattern in the data, as well as the sequential nature of the problem, in order to predict future relations.

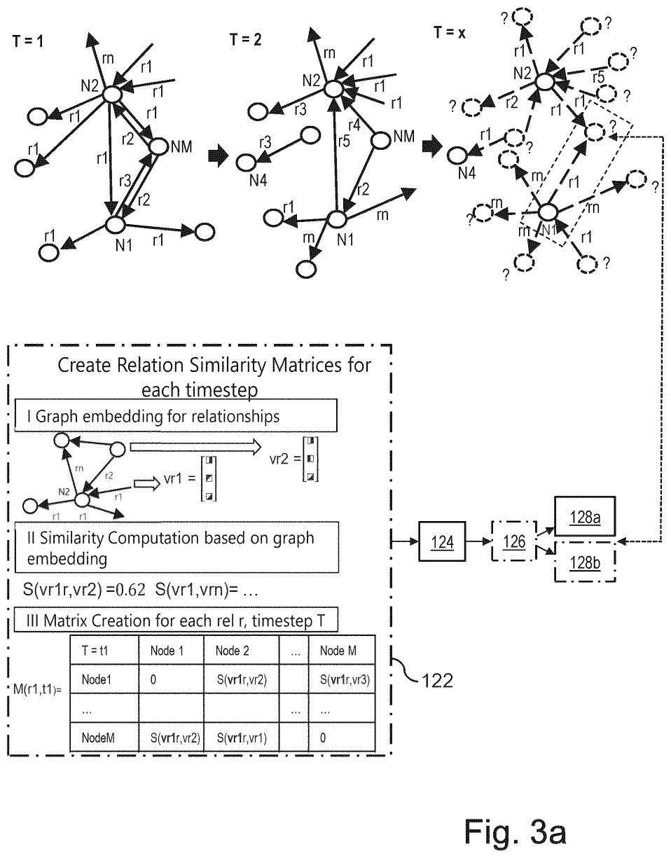

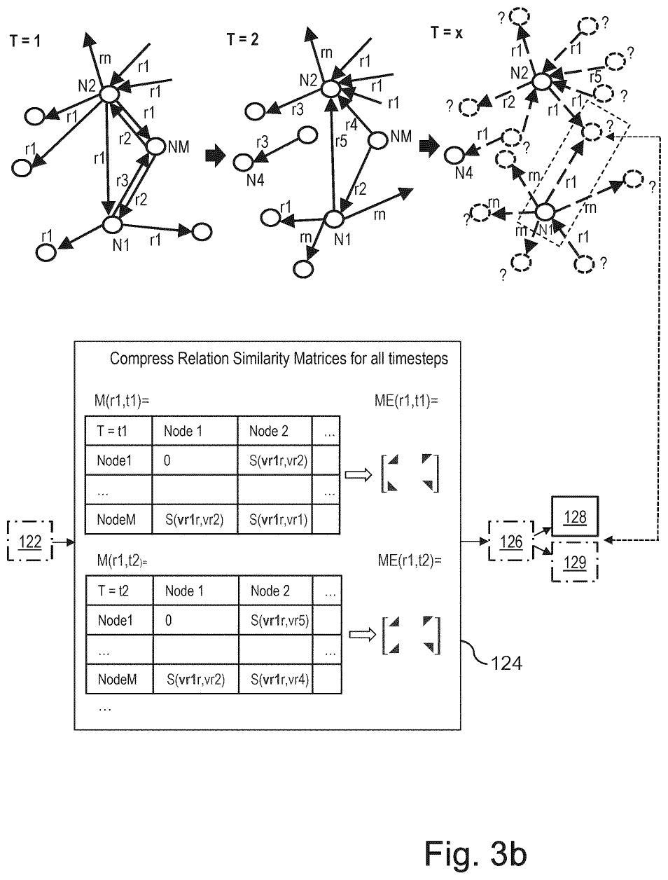

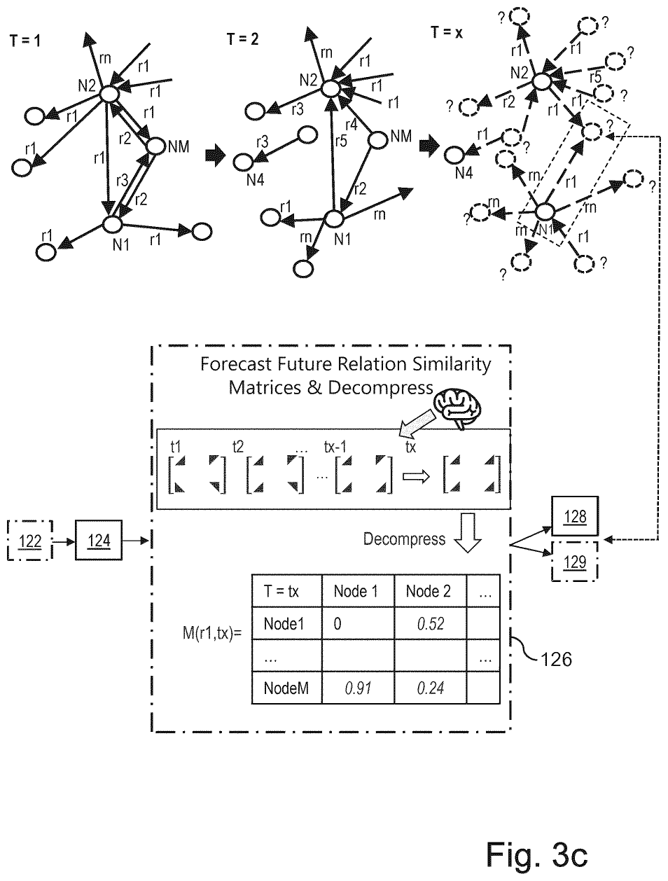

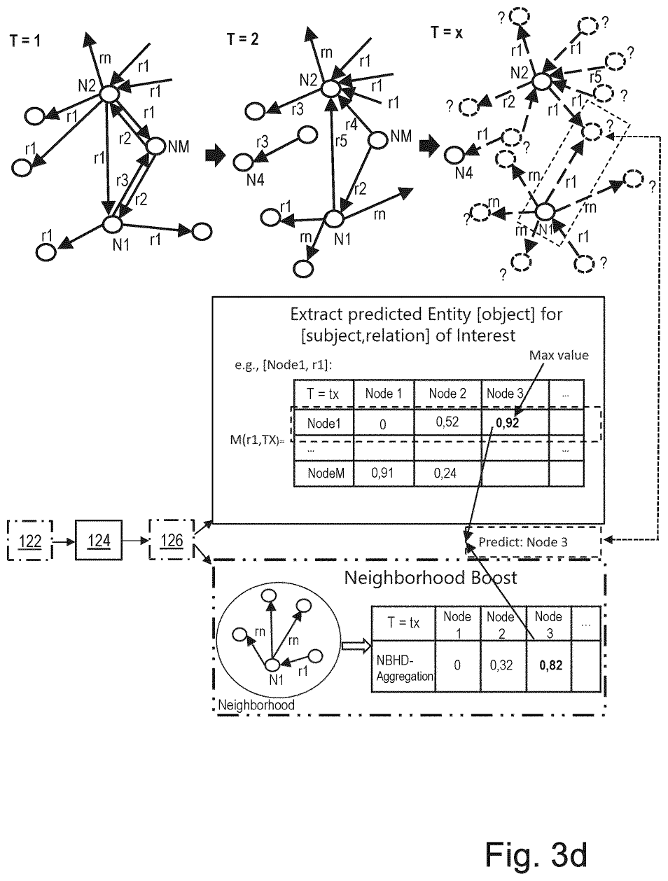

Next, the substeps executed by the entity prediction module 120 will be described with reference to FIGS. 3a-3d.

The goal of the Entity Prediction executed by the entity prediction module 120 is to predict the entities belonging to the relations predicted by the relation prediction module 110 (for instance, by execution of one or more of the steps described above in connection with FIGS. 2a-2d) for the timestep(s) of interest.

As shown in FIG. 1, the entity prediction module 120 may be configured to take as input the predicted relations from the relation prediction module 110. If an outgoing relation was predicted by the relation prediction module 110, the entity prediction module 120 may compute the object for the corresponding predicted [subject, relationship]. On the other hand, if an ingoing relation was predicted by the relation prediction module 110, the entity prediction module 120 may compute the subject for the corresponding predicted [relationship, object]. The entity prediction module 120 will output the predicted entity for all nodes and relations for the timestep(s) of interest. In combination with the output from the relation prediction module 110, these are all the predicted triples, and thus the predicted TKG for the timestep(s) of interest.

FIGS. 3a-3d show possible implementations of sub-steps executed by the entity prediction module 120 in accordance with embodiments of the invention, which we will describe in the following.

### Create Relation Similarity Matrix (Substep 122)

The goal of this substep is to create a matrix for each relation and each timestep that describes the similarity of all other relations to this relation. According to embodiment of the invention, the output, i.e. the relation similarity matrix, will be used (possibly after compression) in the subsequent steps 126 and 128/129, as described in detail further below.

As exemplarily shown in FIG. 3a, the input to the substep 122 are the predicted relations from the relation prediction module 110. Based on these predicted relations, the substep 122 is configured to create multiple relation similarity matrices M, M∈ [symbol] ^{num_nodesxnum_nodes} one matrix per relation r, per timestep T. The elements of the matrix describe how similar the relationships between all nodes are to the relationship r at timestep T. The output of substep 122 are the relation similarity matrices for each relation and each timestep.

For this, a time-independent embedding for each relationship in the graph is computed. For instance, this can be done using any Knowledge Graph Embedding (KGE) technique. In an embodiment of the invention, the KGE technique TransR may be used (for reference, see Yankai Lin, Zhiyuan Liu, Maosong Sun, Yang Liu, and Xuan Zhu: “Learning entity and relation embeddings for knowledge graph completion”, in Twenty-ninth AAAI conference on artificial intelligence. 2015, which is hereby incorporated by reference herein). The Graph Embedding of the relationships may be computed on the full training set, neglecting the time information.

Further, the similarity of each relation in the graph to the other relations is computed, based on the vector similarity of the graph embeddings. In an embodiment of the invention, cosine similarity may be used to compute the value. Relationships, which are more similar, for example call and contact, will have a high similarity, relationships which are less similar, for example call and consist of will have a lower similarity.

Further, a node similarity matrix, a matrix for each relation r, at each timestep T=t, may be created. Its element in line a, column b describes, how similar the relation r_{ab} between node a and node b is to relation r—provided a relation r_{ab} exists. If, for example the relation r is call, and at T=t the triple [node α=Marc, r_{ab}=contact, node b=Joanna] exists in the graph, the node similarity matrix will contain in line a, column b, a value that describes how similar contact is to call. If no relation exists between two nodes, the respective entry will be 0.

Substep 122 is executed to get a time-dependent representation of the graph, containing information about the relations between all nodes, and information on how similar those relations are to the relation of interest over time. According to embodiments of the invention, the created similarity matrices for all relations and timesteps will be used as input for a forecasting model (see substep 126 described below), to predict future relation similarity matrices. According to embodiments of the invention, the future relation similarity matrices will be used to select (see substep 128 described below) the entity of interest. The assumption is that the entity of interest is the node, which is predicted to be addressed by the relation most similar to a selected relation of interest.

### Compress Relation Similarity Matrices (Substep 124)

The goal of this substep is dimensionality reduction. Due to sparsity of the knowledge graph in real world applications, the similarity Matrix M typically consists of a large amount of zero entries. The substep 124 may be configured to compress each similarity matrix to an encoded similarity matrix, hereinafter denoted Me. The output are the encoded similarity matrices for each relation and timestep. In an embodiment of the invention, the dimensionality reduction may be based on an auto-encoder.

As exemplary shown in FIG. 3b, substep 124 may compress each similarity matrix M to an encoded matrix Me M∈ [symbol] ^{nump_ndesxnum_nodes}→Me ∈ [symbol] ^{latent_matrix_dim1xlatent_matrix_dim2}, with latent_matrix_dim1≤num_nodes, and latent_matrix_dim2≤num_nodes.

The encoded matrices have a reduced number of random variables (beneficial for prediction accuracy) and a reduced vector size (beneficial as less memory need).

According to embodiments of the invention, substep 124 may be implemented as technical enhancement and it may be omitted, where appropriate.

### Forecast & Decompress Future Relation Similarity Matrices (Substep 126)

The goal of this substep, exemplarily illustrated in FIG. 3c, is to predict future (encoded) relation similarity matrices based on the sequential input dataset. The input are the (compressed) similarity matrices for all preceding timesteps. The output will be one (decompressed) similarity matrix per relation for the (future) timestep(s) of interest.

The forecasting model may be a sequential model, which learns to predict the future similarity matrix for a relation, based on the past similarity matrices for this relation. In an embodiment, one model is trained per relation, because the goal is to predict the entity connected per relation. According to an embodiment of the invention the forecasting model(s) may be realized by using (per relation) a LSTM (Long Short-Term Memory) as a recurrent neural network, RNN, architecture.

The forecasting model may be configured to learn the (potentially hidden) pattern existent in the data. Since each relation similarity matrix is constructed to contain information on all nodes, global graph information is integrated (in accordance with intuition (fib), as described above). Further, since the input dataset for the forecasting model is provided as sequential data, the model can take into account pattern that have happened before (in accordance with intuition (iia), as described above).

Substep 126 is executed to learn the (potentially hidden) pattern in the relations, connecting the different nodes, as well as the sequential nature of the problem, in order to predict future connections in the graph.

### Select Predicted Most Likely Entity (Substep 128A/128B)

The goal of this substep is to extract the predicted entity for each relation predicted by the relation prediction module 110. The output of this substep is a predicted entity for each relation for the timestep(s) of interest. In combination with the output from relation prediction module 110, these are all the predicted triples, and thus the predicted TKG for the timestep(s) of interest.

According to an embodiment of the invention and as exemplarily illustrated in substep 128a of FIG. 3d, a predicted entity may be extracted from the forecasting model. As such, the selection or extraction is based on the predicted relationship similarity matrix. For a given relation (matrix M) and subject (line in matrix M), the entity (column) with the highest predicted similarity will be selected.

According to an alternative embodiment of the invention and as exemplarily illustrated in substep 128a together with substep 128b of FIG. 3d, the extraction of a predicted entity may be based on a weighted combination of two predictions. The combination weight may be configurable and may be set manually.

The additional substep 128b is constructed to boost the selection for entities, which are also present in the neighborhood of the triple of interest. The underlying intuition is as follows: what happens frequently in the neighborhood, might also happen to the query of interest (in accordance with intuition (iic), as described above). According to this institution, an entity is considered to act similar to its neighborhood, meaning that it will address the same objects as its neighbors (or subjects respectively). An example for this intuition: people tend to buy what their friends buy.

This element is time-independent. For a given node, and its predicted relation, the neighborhood boost element may be configured take into account only the node's neighborhood (across all time steps), for instance 1-hop or 2-hop neighbors. It will compute the similarity of each relation in the neighborhood to the predicted relation (as in substep 124) and create a neighborhood aggregation matrix. The node (column) with the highest (aggregated) similarity value may be selected as predicted entity. According to an embodiment of invention, the aggregation may be computed by a sum of all available neighbor similarity values. According to an alternative embodiment of the invention, the aggregation may be computed by taking the maximum of all available neighbor similarity values.

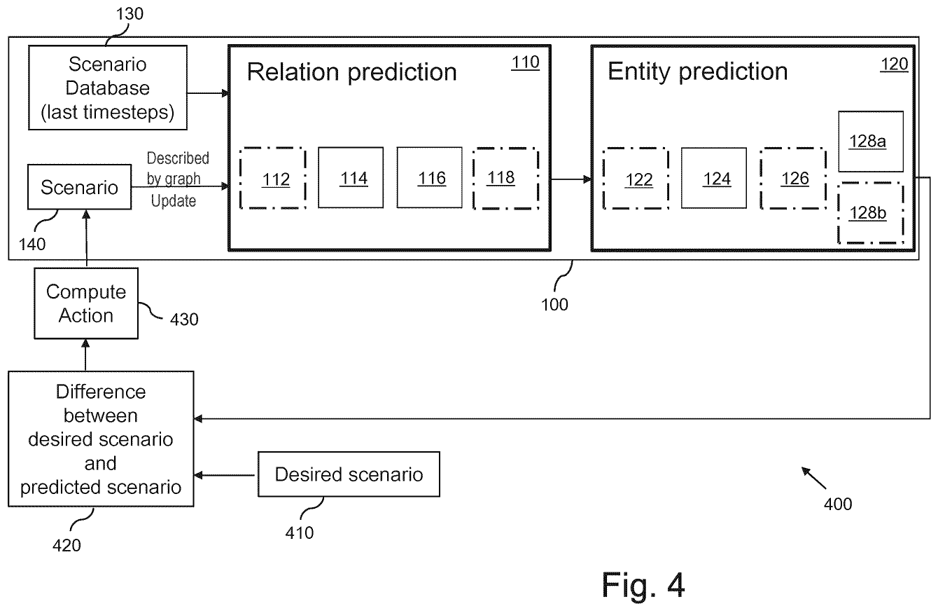

The forecasting system 100 according to embodiments described herein may be embedded in a forecasting-based action recommendation system 400, as exemplarily illustrated in FIG. 4, wherein like reference numerals denote like components as used in FIGS. 1-3.

According to this embodiment, it may be provided that a desired real world scenario 410 is defined by a user. As shown at 420, the system 400 may be configured to compute the difference between the desired (real world) scenario 410 and the predicted (real world) scenario, and compute an action 430 (e.g., selected from a set of predefined potential actions) based on this difference. The action 430 will act on the (real world) scenario 140, which leads to a difference in the (real world) scenario 140. As explained before, the real world scenario 140 is described by a Knowledge Graph (one Knowledge Graph per timestep). The Knowledge Graph will be updated automatically, whenever the real world scenario 140 changes.

Further, the system 400 comprises a (real world) scenario database 130, which contains the state of the real world in the last timesteps. The (real world) scenario database 130, as well as the (real world) scenario 140, serve as an input to the forecast future TKG module comprising the relation prediction module 110 and the entity prediction module 120.

The Forecast Future Graph Module outputs a predicted (real world) scenario—which will then again be the input to compute the difference between the desired (real world) scenario and the predicted (real world) scenario. This loop may be repeated until the desired real world situation is reached, after a predefined number of iterations, or until interruption by the user.

Embodiments of the present invention can be used in many applications where dynamic demand supply assessment may be required, or the need for prevention and action recommendation exists. For example, it can be used in any instance where data with a relation aspect and time component is available. Hereinafter, some concrete application scenarios will be exemplary described in some more detail. In all cases, a differentiator to other existing Knowledge Graph-based Forecasting methods is that the forecasting method according to embodiments of the present invention is able to extract important information and filter out non-important information, and thus to predict in a more enhanced way, namely by detecting pattern in the sequential and relational data in two steps, as described above.

According to a first illustrative application scenario, the forecasting method according to embodiments of the present invention may be applied in the public safety sector, in particular for the purpose of crime prevention, e.g. in the context of a use case where the police observes different areas/districts in a city and records the crimes. The data source could be a database, e.g. of the police force, that contains information of a respective district, including characteristics of the social life, availability of, e.g., schools and police forces, and ethnicities.

The method for TKG forecasting according to embodiments of the invention may observe and predict whether certain districts slip into crime, e.g., the number of crimes increases, or how the number of crimes move among districts, or the crime locations for specific crime types. The TKG forecasting scheme may be configured to produce as output a knowledge graph describing the crimes (locations, witnesses, . . . ) in district(s) of interest per future time step of interest. Further, as integrated in a system for forecast-based action recommendation, the system may output an action (from a set of predefined potential actions) based on the difference between the desired scenario and the predicted scenario. Based on the outputted action, monitoring units (e.g., drones, continuous monitoring is usually not fine) may be added and/or adapted, cleaning androids/units/machines may be sent (might increase the moral), autonomous and mobile library may be sent (give people the chance to educate), advertising on digital advertising panel (screens) may be adapted to fight disinformation, the body cams of police officers may be automatically enabled/disabled (depending on their region).

In this context, embodiments of the present invention provide a predictive policing system, wherein the system comprises
a (police force) database containing crime related scenario states in a number of past timesteps represented as TKGs;
one or more crime prediction processing devices that, alone or in combination, are configured to provide for the execution of the following steps:
generating, based on the TKGs contained in the (police force) database, relationship vectors that describe the relations for each node of the graphs for each available timestep;
using the generated relationship vectors to create a sequential dataset including at least one vector sequence set for each node of the graphs;
using the vector sequence sets as sequential input samples for training and execution of a pattern model that is learned to predict for one or more future timesteps of interest future relations for each node of the graphs;
training and execution of a forecasting model that is learned to predict for one or more future timesteps of interest the nodes of the graphs associated with each of the predicted future relations; and
using the predicted future relations and nodes to assemble predicted future TKGs describing a crime related scenario in an area of interest per future time steps of interest;
a forecasting-based action recommendation system configured to iteratively compute one or more actions acting on the predicted future crime related scenario that steer the predicted future scenario towards a desired scenario; and
control means configured to automatically adapt monitoring and/or surveillance devices deployed in the area of interest based on the computed one or more actions.

The monitoring and/or surveillance devices may be an integral part of the predictive policy system or may be any external devices. In an embodiment, it may be provided that the monitoring and/or surveillance devices provide the data for the crime related scenario states contained in the (police force) database.

According to a second illustrative application scenario, the forecasting method according to embodiments of the present invention may be applied in the digital government sector, in particular for the purpose of infection protection, e.g. in the context of a use case where the government runs a service/app for the society (e.g. an app like for Covid19) to inform people but also to gather information (e.g., whether a person is infected or not). The data source in this case could be a (central) database, which may be part of the back-end of the service/app.

The method for TKG forecasting according to embodiments of the invention may predict, e.g., on a region-level, how a particular infection will develop (i.e., whether it becomes worse or better) at future timestep(s) of interest. The TKG forecasting scheme may be configured to produce as output a list of endangered regions. Further, as integrated in a system for forecast-based action recommendation, the system may output a list of potential counter actions (from a set of predefined potential actions) based on the difference between a desired scenario and the predicted scenario. Based on the outputted action, public buildings may be automatically closed (e.g., adapted opening hours), adapted control of how many people are in a public building may be automatically performed, advertising on digital advertising panel (screens) may be automatically adapted to fight disinformation, the frequency of the public transport may be automatically adapt, and/or autonomous and mobile testing station may be sent.

In this context, embodiments of the present invention provide a predictive infection protection system, wherein the system comprises
a database containing infection related scenario states in a number of past timesteps represented as TKGs;
one or more infection development prediction processing devices that, alone or in combination, are configured to provide for the execution of the following steps:
generating, based on the TKGs contained in the database, relationship vectors that describe the relations for each node of the graphs for each available timestep;
using the generated relationship vectors to create a sequential dataset including at least one vector sequence set for each node of the graphs;
using the vector sequence sets as sequential input samples for training and execution of a pattern model that is learned to predict for one or more future timesteps of interest future relations for each node of the graphs;
training and execution of a forecasting model that is learned to predict for one or more future timesteps of interest the nodes of the graphs associated with each of the predicted future relations; and
using the predicted future relations and nodes to assemble predicted future TKGs describing a infection related scenario in an area of interest per future time steps of interest;
a forecasting-based action recommendation system configured to iteratively compute one or more actions acting on the predicted future infection related scenario that steer the predicted future scenario towards a desired scenario; and
control means configured to automatically adapt access control devices for public buildings, advertising on digital advertising panels, and/or frequency of public transport based on the computed one or more actions.

According to a third illustrative application scenario, the forecasting method according to embodiments of the present invention may be applied in the public services sector, in particular for the purpose of implementing an intelligent assignment and routing scheme in a job center, e.g. in the context of a use case where caseworkers in a job center, who are responsible of the unemployed people, have to group and assign them to activities like a particular training or some integration program, which should increase the chance of actually getting a new job. The data source in this case could be a database of the job center, which may contain information on the job market (available positions, trainings, requirements) and on the people seeking for jobs (qualifications, applications, skills, work experience, interests), as well as information on available caseworkers.

The method for TKG forecasting according to embodiments of the invention may observe and predict how the job market will develop (including information on available jobs and requirements, and on job seekers and their qualifications and interest, and available caseworkers with different qualifications). The TKG forecasting scheme may be configured to produce as output a knowledge graph describing the future job market (including information on available jobs and requirements and on job seekers and their qualifications and interest and available caseworkers with different qualifications) per future time step of interest. Further, as integrated in a system for forecast-based action recommendation, the system may output an action (from a set of predefined potential actions) based on the difference between the desired scenario and the predicted scenario, e.g. assign the job seeker to a training for a domain with promising future. Based on the outputted action, job seekers may be assigned and connected to (potentially virtual) training classes, job seekers may be connected to fitting employers. Furthermore, an intelligent call routing system may be adapted, where the route connects the unemployed person automatically and directly to the most capable agent (for predicted most fitting future domain) which is available or decides to assign the person to a waiting list. Even further, advertising on digital advertising panel (screens) may be adapted to promote future growing job domains, automatically create and adapt job advertisements to fit the needs of the future job market.

In this context, embodiments of the present invention provide a predictive assignment and routing system for a job center, wherein the system comprises
a job center database containing job market related scenario states in a number of past timesteps represented as TKGs, including information on the job market, on people seeking for jobs, and/or on available caseworkers of the job center;
one or more job market development prediction processing devices that, alone or in combination, are configured to provide for the execution of the following steps:
generating, based on the TKGs contained in the job center database, relationship vectors that describe the relations for each node of the graphs for each available timestep;
using the generated relationship vectors to create a sequential dataset including at least one vector sequence set for each node of the graphs;
using the vector sequence sets as sequential input samples for training and execution of a pattern model that is learned to predict for one or more future timesteps of interest future relations for each node of the graphs;
training and execution of a forecasting model that is learned to predict for one or more future timesteps of interest the nodes of the graphs associated with each of the predicted future relations; and
using the predicted future relations and nodes to assemble predicted future TKGs describing a job market related scenario per future time steps of interest;
a forecasting-based action recommendation system configured to iteratively compute one or more actions acting on the predicted future job market related scenario that steer the predicted future scenario towards a desired scenario; and
control means configured to automatically assign and connect job seekers to training classes, adapt an intelligent call routing system of the job center, adapt advertising on digital advertising panels, and/or automatically create and/or adapt job advertisements based on the computed one or more actions.

According to a fourth illustrative application scenario, the forecasting method according to embodiments of the present invention may be applied in the context of demand forecasting, in particular for the purpose of implementing an intelligent demand supply scheme in a supermarket, e.g. in the context of a use case where the available products in a supermarket (supply) should match the demand. The supermarket employees need to make sure to keep a stock that matches the demand to avoid high costs due to under-supply (unsatisfied clients) and over-supply (chucking of expired groceries). The data source in this case could be a database of the supermarket, which may contain information on the sales history for different products, product categories and prices, advertisements and staffing of the supermarket.

The method for TKG forecasting according to embodiments of the invention may observe and predict how the demand in the supermarket will develop for products and product categories of interest taking into account the relations between the products, the advertisements, the information on the supermarket staff, and meta-information like public holidays, events, seasons. The TKG forecasting scheme may be configured to produce as output a knowledge graph describing the future demand in the supermarket (for products and product categories of interest) per future timestep of interest. Further, as integrated in a system for forecast-based action recommendation, the system may output an action (from a set of predefined potential actions) based on the difference between the desired scenario and the predicted scenario, e.g. bake x breads of type z, order y pumpkins, hire more staff for next year. Based on the outputted action, bread baking stations may be automatically operated, product preparation (e.g. sushi) may be automatically adjusted, automated orders from suppliers may be arranged, and/or advertising on digital advertising panel (screens) may be adapted to promote products of interest to match demand and supply.

In this context, embodiments of the present invention provide a predictive demand supply system, for instance of a supermarket, wherein the system comprises
a database, for instance a supermarket database, containing supermarket related scenario states in a number of past timesteps represented as TKGs, including Information on seeds history for different product, product categories and prices, advertisements and/or staffing of the supermarket;
one or more demand development prediction processing devices that, alone or in combination, are configured to provide for the execution of the following steps:
generating, based on the TKGs contained in the database, relationship vectors that describe the relations for each node of the graphs for each available timestep;
using the generated relationship vectors to create a sequential dataset including at least one vector sequence set for each node of the graphs;
using the vector sequence sets as sequential input samples for training and execution of a pattern model that is learned to predict for one or more future timesteps of interest future relations for each node of the graphs;
training and execution of a forecasting model that is learned to predict for one or more future timesteps of interest the nodes of the graphs associated with each of the predicted future relations; and
using the predicted future relations and nodes to assemble predicted future TKGs describing a supermarket related scenario per future time steps of interest;
a forecasting-based action recommendation system configured to iteratively compute one or more actions acting on the predicted future supermarket related scenario that steer the predicted future scenario towards a desired scenario; and
control means configured to automatically adapt operation of food production facilities, generate automated orders from suppliers, adapt advertising on digital advertising panels, and/or promote product of interest based on the computed one or more actions.

According to a fifth illustrative application scenario, the forecasting method according to embodiments of the present invention may be applied in the context of a smart city, in particular for the purpose of flood and disaster prediction and prevention, e.g. in the context of a use case where water level gauges are typically monitored at different locations, with rivers being connected to each other. Further, water levels can be regulated (up to a certain point) by using dams. In case of floods, it is important to take preventive measures (e.g., providing mobile protective walls or sandbag dammings, evacuating residents, ensuring the supply of people in to-be-cut-off regions, and others). The data source in this case could be a water level gauge monitoring system containing information on supply for flood prevention from country/government of interest.

The method for TKG forecasting according to embodiments of the invention may predict the water level and its effect on cities for timesteps of interest, based on past water level but also based on connection to other rivers, information on dam systems, and general flood trend. The TKG forecasting scheme may be configured to produce as output a knowledge graph describing the future water level and its effect on cities per future timestep of interest. Further, as integrated in a system for forecast-based action recommendation, the system may output an action (from a set of predefined potential actions) based on the difference between the desired scenario and the predicted scenario, e.g. provide mobile protective walls. Based on the outputted action, the following physical changes may be arrange: Automated providing and construction of mobile protective walls, automated dam regulation, automated watergate adaptation, automated warning to the population in affected regions through digital warning panel (screens) or text messages, to ensure timely evacuation if needed.

In this context, embodiments of the present invention provide a predictive flood prevention and protection system, wherein the system comprises
a water level gauge monitoring system containing flood related scenario states in a number of past timesteps represented as TKGs;
one or more water level development prediction processing devices that, alone or in combination, are configured to provide for the execution of the following steps:
generating, based on the TKGs contained in the database, relationship vectors that describe the relations for each node of the graphs for each available timestep;
using the generated relationship vectors to create a sequential dataset including at least one vector sequence set for each node of the graphs;
using the vector sequence sets as sequential input samples for training and execution of a pattern model that is learned to predict for one or more future timesteps of interest future relations for each node of the graphs;
training and execution of a forecasting model that is learned to predict for one or more future timesteps of interest the nodes of the graphs associated with each of the predicted future relations; and
using the predicted future relations and nodes to assemble predicted future TKGs describing a flood related scenario in an area of interest per future time steps of interest;
a forecasting-based action recommendation system configured to iteratively compute one or more actions acting on the predicted future flood related scenario that steer the predicted future scenario towards a desired scenario; and
control means configured to automatically provide and/or activate (mobile) flood protection walls, adapt and/or activate automated watergates, execute automatic warning to the population in affected regions through digital warning panels and/or screens and/or text messages.

To conclude, advantageous aspects of embodiments of the present invention are summarized as follows:
By defining the temporal knowledge graph forecasting as two-step pattern recognition model with step 1) Relation Prediction (Predicting the relations independent of the corresponding object) and step 2) Entity Prediction (in a downstream approach for each predicted relation), the invention achieves the advantages of 1) capturing the development of the attributes of an entity across time and 2) capturing occurring patterns for these entities across time and across the full graph. As a consequence, the overall performance of the system is enhanced since all available information are exploited.
By predicting relations based on a matrix that describes the relations for the full graph in a sequential way, it is possible to capture pattern for relationships across the full graph and across time. As a result, the overall performance of the system is enhanced.
By predicting entities (objects) for relations which were never connected to these relations before by exploiting the semantic similarity across existing edge types, it is possible to consider all possible scenarios in the future graphs. As a result, the overall performance of the system is enhanced.
By filtering predicted entities (objects) by exploiting the neighborhood (i.e., similar/related entities) and prioritizing predicted entities, which also occur in the neighborhood, it is possible to exploit all available information. As a result, the overall performance of the system is enhanced.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A predictive policing system, the system comprising:
a database comprising crime related scenario states in a number of past timesteps represented as temporal knowledge graphs (TKGs);
one or more crime prediction processing devices that, alone or in combination, are configured to provide for execution of the following steps:
generating, based on the TKGs stored in the database, relationship vectors that describe relations for each node of the TGKs for each available timestep;
using the generated relationship vectors to create a sequential dataset including at least one vector sequence set for each node of the TKGs;
using the at least one vector sequence sets as sequential input samples for training and execution of a pattern model that is learned to predict, for one or more future timesteps of interest, future relations for each node of the TKGs;
training and execution of a forecasting model that is learned to predict, for one or more future timesteps of interest—the nodes of the TKGs associated with each of the predicted future relations;
using the predicted future relations and nodes to assemble predicted future TKGs describing a crime related scenario in an area of interest per future time steps of interest;
a forecasting-based action recommendation system configured to iteratively compute one or more actions acting on the predicted future crime related scenario that steer the predicted future crime related scenario towards a desired scenario; and
control means configured to automatically adapt monitoring and/or surveillance devices deployed in the area of interest based on the computed one or more actions.

2: A computer-implemented method for Temporal Knowledge Graph (TKG) forecasting, the method comprising:
generating, by a relation prediction module based on a graph database comprising scenario states in a number of past timesteps represented as TKGs, relationship vectors that describe relations for each node of the TKGs for each available timestep;
using, by the relation prediction module, the generated relationship vectors to create a sequential dataset including at least one vector sequence set for each node of the TKGs;
using, by the relation prediction module, the at least one vector sequence sets as sequential input samples for training and execution of a pattern model that is learned to predict, for one or more future timesteps of interest, future relations for each node of the TKGs; and
training and execution, by an entity prediction module, of a forecasting model that is learned to predict, for one or more future timesteps of interest, tie-nodes of the TKGs associated with each of the predicted future relations.

3: The method according to claim 2, further comprising:
computing, by the entity prediction module, a time-dependent graph embedding for each relation contained in the TKGs; and
computing, by the entity prediction module based on a predefined similarity metric, a similarity of each relation contained in the TKGs to each of the other relations contained in the TKGs and creating, based on the computed similarities, relation similarity matrices for each relation and for each timestep.

4: The method according to claim 3, wherein the graph embedding for the relationships is computed on the graph database including scenario states of all available past timesteps.

5: The method according to claim 3, further comprising:
using the relation similarity matrices as sequential input samples for training and execution of the forecasting model that is learned to predict, based on past similarity matrices for a relation, future similarity matrices for the respective relation.

6: The method according to claim 2, wherein the forecasting model is a sequential model implemented in form of a recurrent neural network(RNN).

7: The method according to claim 5, further comprising:
extracting, from the predicted future similarity matrices, for each predicted future relation an entity with a highest predicted similarity and associating the extracted entity with the respective [subject, relation] or [relation, object] pair to obtain all predicted triples of future TKGs for timesteps of interest.

8: The method according to claim 7, wherein the extraction of a predicted entity for a predicted future relation takes into consideration the neighborhood of the respective entity across all timesteps by means of a neighborhood aggregation matrix created by computing, and subsequently aggregating over, the similarity of each relation in the neighborhood of the predicted entity across all timesteps to the respective predicted future relation.

9: The method according to claim 2, further comprising:
encoding the generated relationship vectors for dimensionality reduction prior to creating the sequential dataset, and/or
encoding the relation similarity matrices for dimensionality reduction prior to providing the relation similarity matrices to the forecasting model.

10: The method according to claim 2, further comprising:
embedding the relation prediction module and the entity prediction module in a forecasting-based action recommendation system that iteratively computes appropriate actions acting on a predicted scenario that steer the predicted scenario towards a desired scenario.

11: The method according to claim 2, wherein the graph database is a database containing crime related scenario states in a number of past timesteps represented as TKGs, the method further comprising:
predicting future TKGs describing a crime related scenario in an area of interest per future time steps of interest,
iteratively computing one or more actions acting on the predicted future crime related scenario that steer the predicted future crime related scenario towards a desired scenario, and
automatically adapting monitoring and/or surveillance devices deployed in the area of interest based on the computed one or more actions.

12: The method according to claim 2, wherein the graph database is a database of a public health related infection control service containing infection related scenario states in a number of past timesteps represented as TKGs, the method further comprising:
predicting future TKGs describing infection development on a predefined geographical level per future time steps of interest,
iteratively computing one or more actions acting on the predicted future infection related scenario that steer the predicted future scenario towards a desired scenario, and
automatically adapting access control devices for public buildings, advertising on digital advertising panels, and/or frequency of public transport based on the computed one or more actions.

13: A processing system comprising one or more processors which, alone or in combination, are configured to provide for execution of a method for Temporal Knowledge Graph; (TKG); forecasting, the method comprising:
generating, by a relation prediction module based on a graph database comprising scenario states in a number of past timesteps represented as TKGs, relationship vectors that describe relations for each node of the graphs for each available timestep;
using, by the relation prediction module, the generated relationship vectors to create a sequential dataset including at least one vector sequence set for each node of the TKGs;
using, by the relation prediction module, the at least one vector sequence sets as sequential input samples for training and execution of a pattern model that is learned to predict, for one or more future timesteps of interests future relations for each node of the TKGs; and
training and execution, by an entity prediction module, of a forecasting model that is learned to predict, for one or more future timesteps of interest, tie-nodes of the TKGs associated with each of the predicted future relations.

14: The system according to claim 13, further comprising:
a forecasting-based action recommendation system configured to iteratively compute appropriate actions acting on a predicted scenario that steer the predicted scenario towards a desired scenario.

15: A tangible, non-transitory computer-readable medium having instructions thereon which, upon being executed by one or more processors, alone or in combination, provide for execution of a method of Temporal Knowledge Graph; (TKG) forecasting, the method comprising:
generating, by a relation prediction module based on a graph database comprising scenario states in a number of past timesteps represented as TKGs, relationship vectors that describe relations for each node of the graphs for each available timestep;
using, by the relation prediction module, the generated relationship vectors to create a sequential dataset including at least one vector sequence set for each node of the TKGs;
using, by the relation prediction module, the at least one vector sequence sets as sequential input samples for training and execution of a pattern model that is learned to predict, for one or more future timesteps of interests future relations for each node of the TKGs; and
training and execution, by an entity prediction module, of a forecasting model that is learned to predict, for one or more future timesteps of interest, nodes of the TKGs associated with each of the predicted future relations.
